(19) United States
(12) Patent Application Publication
(10) Pub. No.: US 2011/0076359 A1
(43) Pub. Date: Mar. 31, 2011

(54) REMOVING GAS ADDITIVES FROM RAW MILK

(75) Inventors: Kirby D. Hayes, Broomfield, CO (US); Tricia A. Brannigan, Louisville, CO (US); Kenneth W. Laughlin, Broomfield, CO (US); Steven Lim, Longmont, CO (US); Bernard S. Fonseca, Erie, CO (US)

(73) Assignee: Dean Intellectual Property Services, Inc., Dallas, TX (US)

(21) Appl. No.: 12/771,785

(22) Filed: Apr. 30, 2010

Related U.S. Application Data
(60) Provisional application No. 61/246,419, filed on Sep. 28, 2009.

(51) Int. Cl. A23C 9/14; A23C 3/00; A23C 9/12; A23C 9/142; A23L 3/015; A23C 1/00

(52) U.S. Cl. 426/42; 426/238; 426/234; 426/487; 99/451; 99/454

(57) ABSTRACT

According to one embodiment of the present invention, a milk processing system receives a mixture including milk and one or more gas additives. The system sonicates the mixture according to sonication settings selected to reduce the amount of gas in the milk. The sonication settings include a frequency, a power, and a predetermined amount of time.

### RELATED APPLICATIONS

This application claims the benefit of priority under 35 U.S.C. §119(e) of U.S. Provisional Application Ser. No. 61/246,419, filed Sep. 28, 2009, and entitled “REMOVING CARBON DIOXIDE FROM GAS TREATED MILK.”

### TECHNICAL FIELD

This invention relates generally to the field of milk processing and more specifically to removing gas additives from gas treated milk.

### BACKGROUND

Raw milk may contain microorganisms, such as psychrotrophic pathogens, psychrotrophic spoilage microbes, and deleterious enzymes. Microorganism growth may occur over time and may reduce the safety and quality of the raw milk. As a result, the storage life of the raw milk may be relatively short.

Adding carbon dioxide (CO₂) to the raw milk may reduce the growth rate of the microorganisms, thereby increasing the storage life of the raw milk and allowing it to be shipped over long distances. For example, U.S. Patent Application Publication No. 2005/0260309 discloses “Extended Shelf Life and Bulk Transport of Perishable Organic Liquids with Low Pressure Carbon Dioxide.” The CO₂ may be removed prior to processing the raw milk into a finished product. Removal of the added CO₂ may be required for the Food and Drug Administration (FDA) to approve the use of CO₂ as a raw milk additive.

### SUMMARY OF THE DISCLOSURE

According to one embodiment of the present invention, a milk processing system receives a mixture including milk and one or more gas additives. The system sonicates the mixture according to sonication settings selected to reduce the amount of gas in the milk. The sonication settings include a frequency, a power, and a predetermined amount of time.

Certain embodiments of the invention may provide one or more technical advantages. A technical advantage of one embodiment may be that the amount of heat required to remove gas from milk may be reduced as compared to known carbon dioxide removal systems. Reducing heat requirements may reduce energy requirements and costs. Additionally, problems associated with exposing milk to high heat, such as destruction of nutritional components or creation of unwanted flavors, may be reduced.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example of a gas injection system for generating gas treated milk; and

FIG. 2 illustrates an example of a system for removing gas additives from gas treated milk.

### DETAILED DESCRIPTION OF THE DRAWINGS

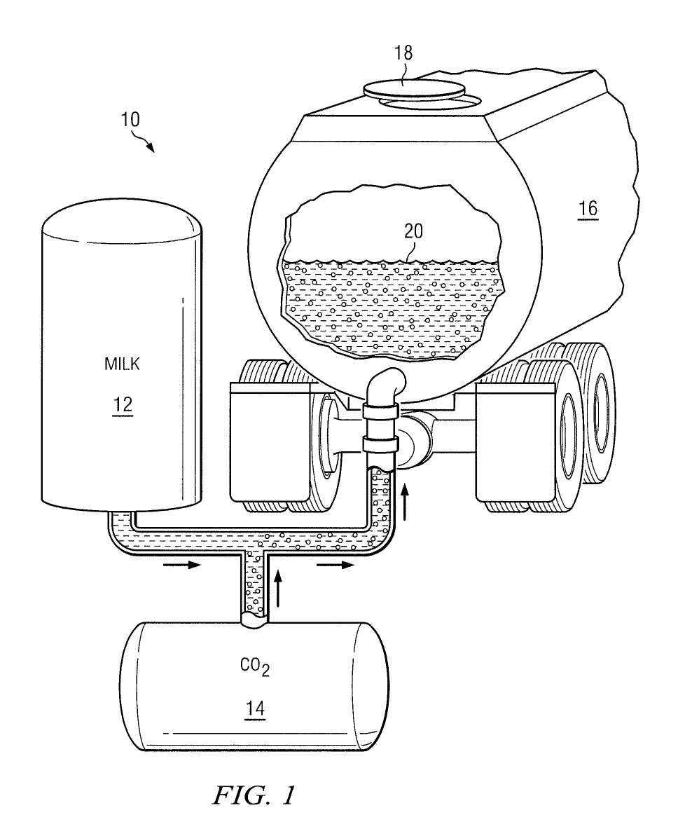

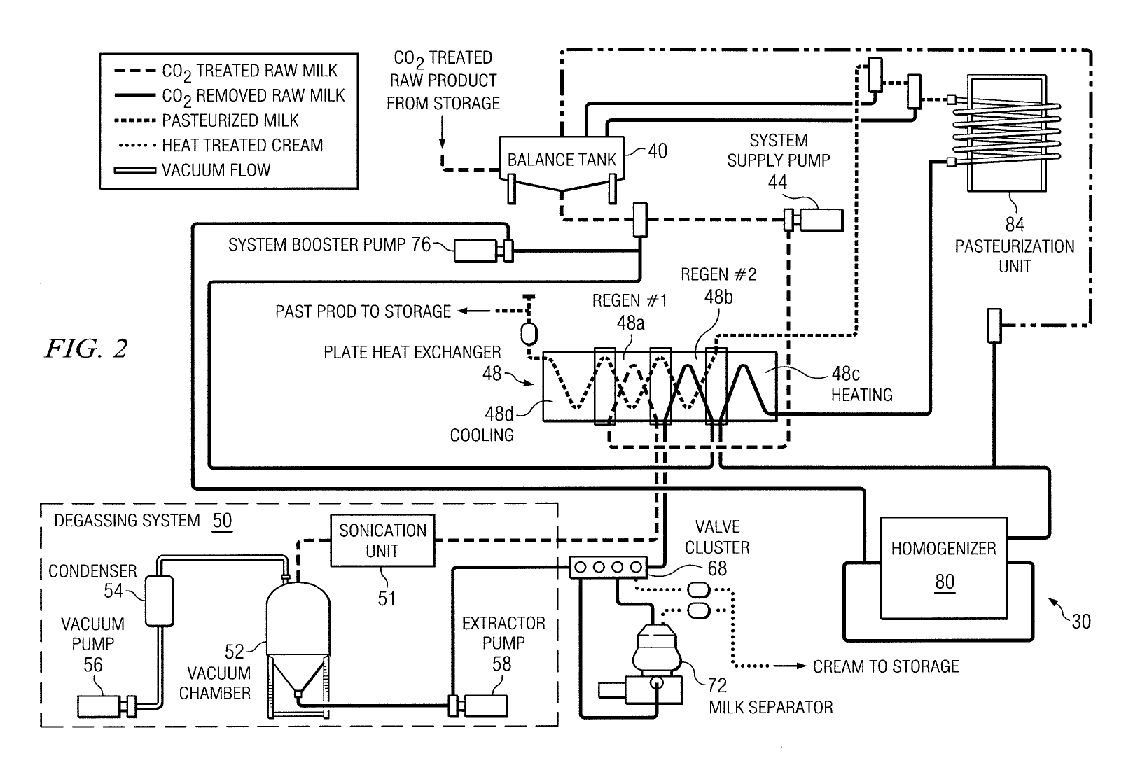

Embodiments of the present invention and its advantages are best understood by referring to FIGS. 1-2 of the drawings, like numerals being used for like and corresponding parts of the various drawings.

One or more gases may be added to raw milk to extend the storage life of raw milk and to allow for shipping raw milk over long distances. The gas additives may be removed prior to processing the raw milk into a finished product. Removal of the added gas may be required for the Food and Drug Administration (FDA) to approve the use of gas as a raw milk additive.

Known systems may add carbon dioxide to milk. These known systems may remove CO₂ from milk by applying high heat (−155° F.) and vacuum. Known systems, however, may require holding the heated milk for an extended period of time compared to traditional regenerative preheating that may typically be used for ungas treated milk. Holding heated milk for an extended period of time may require high energy inputs, may destroy nutritional components of the milk, and may create unwanted flavors. In accordance with the present invention, disadvantages and problems associated with known techniques for removing added CO₂ from milk may be reduced or eliminated. For example, certain embodiments may include a sonication procedure to aid in the CO₂ removal without requiring high heat.

FIG. 1 illustrates an example of a gas injection system for adding gas to raw milk to form a mixture, however, any system for adding gas to raw milk may be used. Examples of gases that may be added to raw milk include carbon dioxide, nitrogen, carbon monoxide, sulfur dioxide, ozone, hydrogen, and/or a combination, for example, carbon dioxide (CO₂). The gas injection system may include a raw milk source 12, a CO₂ source 14, and a vessel 16. In some embodiments, the raw milk source 12 may direct raw milk to the vessel 16. Prior to adding the CO₂, the raw milk may have a pH of approximately 6.6 and a CO₂ concentration of approximately 10-400 parts per million (ppm), such as 80-100 ppm. The temperature of the raw milk may be less than approximately 45° F. In some embodiments, the CO₂ source 14 may direct CO₂ gas to the vessel 16. The flow rate of the CO₂ gas may be determined based on the flow rate of the raw milk into the vessel 16 and the concentration of CO₂ to be achieved in the mixture.

The vessel 16 may include a pressure relief valve 18, and may hold gas treated milk 20. In some embodiments, the head pressure of the vessel 16 may be approximately zero pounds per square inch gauge (psig) prior to receiving the gas treated milk 20. The vessel 16 may be filled by pumping raw milk from the raw milk source 12 and CO₂ from the CO₂ source 14 into the vessel 16. In some embodiments, the amount of CO₂ pumped by the CO₂ source 14 may be selected to yield a concentration of 1700-2800 ppm of CO₂ in the gas treated milk 20, such as 2100-2400 ppm. The resulting pH may range from approximately 5.9 to 6.2. The CO₂ and raw milk may be pumped into the vessel 16 with or without head pressure. In some embodiments, a head pressure of approximately 25 psig or less may be maintained while filling the vessel 16. The pressure relief valve 18 may release air as needed to maintain the head pressure. Once the vessel 16 has been substantially filled with the gas treated milk 20, the pressure relief valve 18 may be opened to allow the head pressure to decompress. In some embodiments, the vessel 16 may be resealed when the head pressure is approximately equal to 0 psig.

In some embodiments, the filled vessel 16 may be shipped to a milk processing location. During storage and/or shipment, the gas treated milk 20 shall have a temperature less than approximately 45° F. In some embodiments, the gas treated milk 20 may maintain its microbial integrity for greater than 72 hours. For example, milk treated with carbon dioxide may maintain its microbial integrity for approximately ten days. Maintaining the microbial integrity of the raw milk for longer periods of time may allow for shipping over relatively long distances, such as across North America. In some embodiments, the CO₂ may be removed from the gas treated milk 20 at the milk processing location. Although the example has been described in the context of carbon dioxide, similar techniques may be used to add other gases to milk.

FIG. 2 illustrates an example of a system 30 for removing added gas from milk. The system 30 may be any suitable milk processing system. In some embodiments, system 30 may comprise a heat exchange system, such as a high temperature/short time (HTST) system, an extended shelf life (ESL) system, an ultra-high temperature (UHT) system, a higher heat/shorter time (HHST) system, or a “bulk” or “batch” pasteurization system. As an example, HTST embodiments of the system 30 may include a balance tank 40, a system supply pump 44, a plate heat exchanger 48, a degassing system 50 (e.g., a sonication unit 51, a vacuum chamber 52, a condenser 54, a vacuum pump 56, and an extractor pump 58), a valve cluster 68, a milk separator 72, a system booster pump 76, a homogenizer 80, a pasteurization unit 84, a storage element, and/or other suitable elements.

According to some embodiments, gas treated milk may be directed from storage to the system 30. The gas treated milk may enter the system 30 at a balance tank 40 that supplies constant levels of milk to the other elements. From the balance tank 40, the gas treated milk may flow to a system supply pump 44, where the pressure at which milk moves through the system 30 may be controlled. The gas treated milk may continue to a heater, such as plate heat exchanger 48.

According to some embodiments, the plate heat exchanger 48 may control the temperature of the milk. The plate heat exchanger 48 may comprise multiple sections, such as a first regeneration section 48a, a second regeneration section 48b, a heating section 48c, and a cooling section 48d. Each section of the plate heat exchanger 48 may control the temperature of the milk at different points in the treatment process. For example, the gas treated milk received from the system supply pump 44 may be received at the first regeneration section 48a of the plate heat exchanger 48.

In some embodiments, section 48a may heat the gas treated milk using regenerative heating. Regenerative heating may transfer heat from the pasteurized milk exiting the system 30 to the incoming gas treated milk. Thus, the amount of energy required to heat the cold gas treated milk and to cool the outgoing pasteurized milk may be reduced. In some embodiments, the gas treated milk may be heated to a temperature in the range of approximately 35° F. to 165° F., such as approximately 35° F. to 100° F. Note that gas treated milk may be received from storage having a temperature in the lower part of the range, and heating may not be required.

Upon exiting the section 48a, the gas treated milk may be directed to a degassing system 50. In some embodiments, the degassing system 50 may include a sonication unit 51, a vacuum chamber 52, a condenser 54, a vacuum pump 56, and/or an extractor pump 58. The sonication unit 51 may apply sound energy to agitate the milk particles. The gas treated milk may be sonicated for a predetermined amount of time at a frequency and a power. In some embodiments, the predetermined amount of time may be in the range of approximately 0.01 to 30 minutes, the frequency may be in the range of approximately 10 to 40 KHz, and the power may be in the range of approximately 0.5 to 50 kW.

The gas treated milk may be directed from the sonication unit 51 to a vacuum chamber 52. In some embodiments, the gas treated milk may enter the vacuum chamber 52 at a continuous flow, with a flow rate in the range of approximately 30-150 gallons per minute, such as 60 gallons per minute. In some embodiments, a spray nozzle or tangential inlet may deliver a stream of milk to the vacuum chamber 52. In some embodiments, the spray nozzle may shape the stream to expose a large surface area of milk to vacuum pressure. Exposing the gas treated milk to vacuum pressure may aid in the removal of the added gas. For example, in embodiments using added carbon dioxide, the CO₂ concentration may be reduced to a level similar to that of raw milk to which CO₂ has not been added, for example, less than 400 ppm, such as less than 200 ppm. In addition to removing gas additives, the vacuum pressure may remove volatile compounds from the milk that may be associated with the type of feed ingested by the livestock that supplied the milk.

According to some embodiments, vacuum pressure may be generated in the vacuum chamber using a vacuum pump 56. The vacuum pressure may range from approximately 0 to −28 inches of mercury (Hg), such as −24.5 inches Hg. In some embodiments, a condenser 54 may cool the milk vapors removed from the vacuum chamber 52 to condense them from gaseous form to liquid form. Any suitable condenser may be used, such as a shell and tube heat exchanger. A shell and tube heat exchanger may include an outer shell with a bundle of tubes inside it. Hot milk vapors may enter the shell side and flow over the tubes while a cooling liquid, such as cold water, runs through the tubes to cool the milk vapors in order to yield a liquid. The liquid formed by cooling the milk vapors may then be removed from the system 30.

Once the added gas has been substantially removed, the raw milk may be extracted from the vacuum chamber 52 and sent to the next elements for further processing. For example, an extractor pump 58 may pump the raw milk from the vacuum chamber 52 and direct the raw milk out of the degassing system 50.

Upon exiting the degassing system 50, the raw milk may be directed to a valve cluster 68. The valve cluster 68 may send raw milk to a milk separator 72 or to the plate heat exchanger 48. The milk separator 72 may separate the raw milk into cream and skim milk. For example, the milk separator 72 may rapidly rotate the milk to generate centrifugal forces that may separate the milk. As the skim milk leaves the milk separator 72, it may be returned to the valve cluster 68. As the cream leaves the milk separator 72, it may be directed out of the system 30 for storage or returned to the valve cluster 68 to be recombined with the skim milk. The amount of recombined cream may be selected to form a certain type of milk, such as 1% milk, 2% milk, or whole milk.

The valve cluster 68 may send the raw skim or recombined milk from the milk separator 72 to the plate heat exchanger 48. Alternatively, the valve cluster 68 may send raw milk directly from the extractor pump 58 to the plate heat exchanger 48, bypassing the milk separator 72. In some embodiments, the valve cluster 68 may send the raw milk to be heated by the second regeneration section 48b of the plate heat exchanger 48. The heated raw milk may be directed from the plate heat exchanger 48 to a homogenizer 80. In some embodiments, system 30 may include a system booster pump 76 to ensure the raw milk flows to the homogenizer 80 at a proper pressure.

The homogenizer 80 may process the raw milk so that the cream and skim portions are evenly dispersed throughout. Homogenization may prevent or delay the natural separation of the cream portion from the skim portion of the milk. In some embodiments, the raw milk may be homogenized by forcing it through a restricted orifice at approximately 1800 pounds per square inch. The process may shear the raw milk particles thereby allowing for even dispersion throughout the milk. Note that in some embodiments, the sonication unit 51 may be operable to generate a desired particle size without requiring the milk to be processed by other homogenization means (i.e., homogenizer 80 may be bypassed).

According to some embodiments, the homogenized milk from the homogenizer 80 may be diverted to the balance tank 40, or may continue on to the plate heat exchanger 48. The milk may be diverted to the balance tank 40 to facilitate a recovery in the event system 30 shuts down abruptly. For example, the balance tank 40 may re-circulate the milk through the system 30 if the amount of new milk received is not adequate to supply the system 30. Upon a determination that the homogenized milk need not be diverted, the milk may continue to the heating section 48c of the plate heat exchanger to be heated for pasteurization.

The heating section 48c may heat the raw milk to pasteurization temperature using temperature controlled hot water. In some embodiments, the heating section 48c may heat the raw milk to a temperature in the range of approximately 160° F. to 165° F. The heated raw milk may be sent to a pasteurization unit 84.

In some embodiments the pasteurization unit 84 may be a hold tube and flow diversion unit. The flow rate of the raw milk through the tube may be selected based on the dimensions of the tube to ensure the raw milk is exposed to pasteurization temperatures for enough time to achieve pasteurization, such as 15 to 30 seconds. If the pasteurization requirements are not met, the milk may be diverted to the balance tank 40 to be re-circulated through the processing system. If pasteurization is successful, the pasteurized (finished) milk may be returned to the plate heat exchanger 48 to be cooled in the cooling section 48d. The cooling section 48d may allow heat to transfer from the hot pasteurized milk to chilled glycol or water. Upon reaching a storage temperature, such as 35° F., the pasteurized milk exits system 30 and is sent to post production storage. The pasteurized milk may have storage life similar to pasteurized milk that has not been treated with gas, such as approximately three weeks.

According to some embodiments, the milk processing system may be configured to remove adequate amounts of gas from the gas treated milk. Configurable settings may include the initial concentration of the gas in the milk, the sonication settings, the temperature of the milk, the flow rate of the milk into the vacuum chamber, the negative pressure in the vacuum chamber, and the surface area of the milk exposed to the vacuum pressure. The following values are provided for example purposes, however, any suitable values may be used. In some embodiments, the concentration of the gas in the gas treated milk may range from approximately 1700-2800 ppm. The milk may be sonicated for 0.01 to 30 minutes at a frequency between 10 and 40 KHz and a power of 0.5 to 50 kW. The milk received by the vacuum chamber may have a temperature in the range of approximately 35° F. to 165° F., such as approximately 35° F. to 100° F. The flow rate of the milk entering the vacuum chamber may range from approximately 30-150 gallons per minute, such as 60 gallons per minute. The vacuum pressure may range from approximately 0 to −28 inches Hg, such as −24.5 inches Hg. The surface area may be selected to expose a relatively large surface area to the negative vacuum pressure. The surface area may be created using any suitable means, such as dispersing the milk through a spray nozzle or allowing the milk to pour over a surface (e.g., a side wall of the vacuum chamber, a parabolic shaped nozzle, or other surface contained within the vacuum chamber).

Modifications, additions, or omissions may be made to system 30 without departing from the scope of the invention. The components of system 30 may be integrated or separated. Moreover, the operations of system 30 may be performed by more, fewer, or other components. Additionally, operations of system 30 may be performed in any suitable order using any suitable element. For example, in some embodiments, the degassing system 50 may comprise any system suitable for removing gas from gas treated milk, such as one or more of: a degassing pump, a membrane, an enzyme, a sonication unit, and a vacuum system (e.g., vacuum chamber, condenser, vacuum pump, and extractor pump).

A degassing pump may separate milk particles from gas particles based on the difference in the densities of the particles. For example, the degassing pump may generate a centrifugal force that separates lower-density gas particles from higher-density milk particles. In some embodiments, the degassing pump may receive milk having a temperature in the range of approximately 35° F. to 165° F.

A membrane may separate milk particles from gas particles based on particle size. For example, the membrane may allow smaller gas particles to pass through, while preventing larger milk particles from passing. In some embodiments, the membrane may receive milk having a temperature in the range of approximately 35° F. to 165 ° F.

Enzyme-mediated degassing may use an enzyme to convert gas into other components. For example, enzymes may convert carbon dioxide gas to carbonic acid or other carbon-based component (e.g., bicarbonates or similar compounds). As an example, carbonic anhydrase may be used to convert carbon dioxide to a carbon-based component. Carbon-based components may be removed from the milk using any suitable technique. In some embodiments, the enzyme-degassed milk may be directed to other degassing components, such as a vacuum system, to remove additional gas particles. Alternatively, the enzyme-degassed milk may continue through to other milk processing components without further degassing. In some embodiments, the enzyme-mediated degassing may be applied to milk having a temperature in the range of approximately 35° F. to 165° F., such as approximately 35° F. to 100° F.

Certain embodiments of the invention may provide one or more technical advantages. A technical advantage of one embodiment may be that the amount of heat required to remove added gas from milk may be reduced as compared to known carbon dioxide removal systems. For example, known systems may require heating milk to approximately 155° F. to remove added carbon dioxide from milk. Embodiments of the present disclosure, however, may remove added gas at temperatures in the range of approximately 35° F. to 100° F. Reducing heat requirements may reduce energy requirements and costs. Additionally, problems associated with exposing milk to high heat, such as destruction of nutritional components or creation of unwanted flavors, may be reduced.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method, comprising:
receiving a mixture including milk and one or more gas additives at a milk processing system, the milk processing system including elements for processing milk; and
sonicating the mixture according to sonication settings selected to reduce the amount of gas in the milk, the sonication settings including:
a frequency;
a power; and
a predetermined amount of time.

2. The method of claim 1, further comprising:
directing the mixture into a vacuum chamber;
applying a vacuum pressure to the mixture while dispersing the mixture into the vacuum chamber, the vacuum pressure selected to substantially remove the added gas from the mixture; and
extracting the milk, with the added gas substantially removed, from the vacuum chamber.

3. The method of claim 1, further comprising:
directing the mixture into a vacuum chamber at a rate of approximately 30-150 gallons per minute;
applying a vacuum pressure to the mixture while dispersing the mixture into the vacuum chamber, the vacuum pressure in the range of approximately 0 to negative 28 inches of mercury and selected to substantially remove the added gas from the mixture; and
extracting the milk, with the added gas substantially removed, from the vacuum chamber.

4. The method of claim 1, wherein the mixture includes approximately 1700-2800 parts per million added gas.

5. The method of claim 1, wherein the temperature of the mixture is in the range of approximately 35-165 degrees Fahrenheit during sonication.

6. The method of claim 1, further comprising the predetermined amount of time in the range of approximately 0.01 to 30 minutes.

7. The method of claim 1, further comprising the frequency in the range of approximately 10 to 40 kHz.

8. The method of claim 1, further comprising the power in the range of approximately 0.5 to 50 kW.

9. The method of claim 1, further comprising the frequency in the range of approximately 10 to 40 kHz and the power in the range of approximately 0.5 to 50 kW.

10. The method of claim 1, further comprising the predetermined amount of time in the range of approximately 0.01 to 30 minutes, the frequency in the range of approximately 10 to 40 kHz, and the power in the range of approximately 0.5 to 50 kW.

11. The method of claim 1, further comprising homogenizing and pasteurizing the milk after the gas additives have been substantially removed.

12. The method of claim 1, wherein the mixture received by the milk processing system is formed by:
preparing a vessel with a head pressure of approximately 0 psig;
directing the one or more gas additives and the milk to the vessel;
filling the vessel with the gas additives and the milk while maintaining a head pressure of approximately 25 psig or less;
decompressing the head pressure to approximately 0 psig after the vessel has been substantially filled; and
sealing the vessel.

13. The method of claim 1, wherein the mixture received by the milk processing system is formed by:
directing the one or more gas additives and the milk to a vessel;
filling the vessel without head pressure; and
sealing the vessel.

14. The method of claim 1, wherein at least one of the one or more gas additives is selected from the group consisting of carbon dioxide, nitrogen, carbon monoxide, sulfur dioxide, ozone, and hydrogen.

15. A milk processing system, comprising:
a sonication unit configured to:
receive a mixture including milk and one or more gas additives; and
sonicate the mixture according to sonication settings selected to reduce the amount of gas in the milk, the sonication settings including:
a frequency;
a power; and
a predetermined amount of time.

16. The milk processing system of claim 15, further comprising:
a vacuum chamber configured to:
receive the mixture;
apply a vacuum pressure to the mixture; and
substantially remove the added gas from the mixture.

17. The milk processing system of claim 15, further comprising:
a heater configured to heat the mixture to a temperature in the range of approximately 35-165 degrees Fahrenheit;
a vacuum chamber configured to apply a vacuum pressure to the mixture, the vacuum pressure in the range of approximately 0 to −28 inches Hg and selected to substantially remove the added gas from the mixture; and
an inlet operable to disperse a stream of the mixture into the vacuum chamber by cascading the mixture down a side wall of the vacuum chamber or directing the stream to a nozzle operable to disperse the stream.

18. The milk processing system of claim 15, wherein:
the mixture includes approximately 1700-2800 parts per million gas.

19. The milk processing system of claim 15, further including:
a balance tank for controlling a supply of milk to other elements of the milk processing system;
a vacuum pump for generating negative vacuum pressure in the vacuum chamber;
an extractor pump for extracting the milk, with the gas substantially removed, from the vacuum chamber;
a milk separator for separating the milk into skim milk and cream; and
a pasteurization unit for pasteurizing the milk to slow microbial growth.

20. The milk processing system of claim 15, further comprising the predetermined amount of time in the range of approximately 0.01 to 30 minutes, the frequency in the range of approximately 10 to 40 kHz, and the power in the range of approximately 0.5 to 50 kW.

21. The milk processing system of claim 15, further comprising:
a vacuum chamber configured to:
receive the mixture at a rate of approximately 30-150 gallons per minute;
apply a vacuum pressure to the mixture; and
remove the added gas from the mixture until the mixture comprises less than approximately 400 ppm gas.

22. A method, comprising:
receiving a mixture at a milk processing system, the mixture including:
milk comprising milk particles having a first density; and
one or more gas additives comprising gas particles having a second density;
processing the mixture using a degassing pump, the degassing pump configured to separate the milk particles and the added gas particles based on a difference in the first density and the second density;
determining that the gas particles have been substantially removed; and
sending the milk to a next element of the milk processing system.

23. The method of claim 22, wherein the mixture comprises 1700-2800 ppm added gas and the milk comprises less than approximately 400 ppm gas after the gas particles have been substantially removed.

24. The method of claim 22, wherein at least one of the one or more gas additives is selected from the group consisting of carbon dioxide, nitrogen, carbon monoxide, sulfur dioxide, ozone, and hydrogen.

25. A method, comprising:
receiving a mixture at a milk processing system, the mixture including:
milk comprising milk particles having a first particle size; and
one or more gas additives comprising gas particles having a second particle size;
processing the milk using a membrane, the membrane configured to separate the milk particles from the added gas particles based on a difference in the first particle size and the second particle size;
determining that the gas particles have been substantially removed; and
sending the milk to a next element of the milk processing system.

26. The method of claim 25, wherein the mixture comprises 1700-2800 ppm added gas and the milk comprises less than approximately 400 ppm gas after the gas particles have been substantially removed.

27. The method of claim 25, wherein at least one of the one or more gas additives is selected from the group consisting of carbon dioxide, nitrogen, carbon monoxide, sulfur dioxide, ozone, and hydrogen.

28. A method, comprising:
receiving a mixture including milk and one or more gas additives at a milk processing system, the milk processing system including elements for processing milk;
adding an enzyme to the mixture, the enzyme selected to convert the added gas to a component;
substantially removing the component from the milk; and
sending the milk to a next element of the milk processing system.

29. The method of claim 28, wherein the mixture comprises 1700-2800 ppm added gas and the milk comprises less than approximately 400 ppm gas after the gas particles have been substantially removed.

30. The method of claim 28, wherein at least one of the one or more gas additives is selected from the group consisting of carbon dioxide, nitrogen, carbon monoxide, sulfur dioxide, ozone, and hydrogen.
